(19) United States
(12) Patent Application Publication
(10) Pub. No.: US 2015/0092393 A1
(43) Pub. Date: Apr. 2, 2015

(54) LIGHTING SYSTEM

(71) Applicant: Caterpillar Paving Products Inc., Brooklyn Park, MN (US)

(72) Inventors: Nicholas A. Oetken, Minneapolis, MN (US); John L. Marsolek, Minneapolis, MN (US); Travis A. Ohlgren, Minneapolis, MN (US)

(73) Assignee: Caterpillar Paving Products Inc., Brooklyn Park, MN (US)

(21) Appl. No.: 14/564,160

(22) Filed: Dec. 9, 2014

(51) Int. Cl. F21V 23/00; F21V 33/00

(52) U.S. Cl. CPC F21V 23/003; F21V 33/00; F21W 2131/403
USPC 362/89

(57) ABSTRACT

A lighting system for a work machine is provided. The lighting system includes a plurality of step lights disposed on a stairway of the work machine. The lighting system further includes a lighting power source configured to provide power to the plurality of step lights for lighting, independently of an operational state of the work machine. The lighting system also includes a radio frequency identification reader configured to read a radio frequency identification tag associated with an operator. The lighting system further includes a lighting control module configured to receive a signal based on the reading of the radio frequency identification tag. The lighting control module further detects if the operator is proximate to the work machine. The lighting control module further triggers an activation of the plurality of step lights based on the detection of the operator proximate to the work machine.

### TECHNICAL FIELD

The present disclosure relates to a lighting system for a work machine, and more particularly to the lighting system provided on the work machine for aiding an operator to climb onto the work machine in low lighting conditions.

### BACKGROUND

Large machines, such as, for example, wheel loaders, off-highway haul trucks, excavators, motor graders, and other types of earth-moving machines are used to perform a variety of tasks. Sometimes such mentioned machines are operated or are kept within mines or low light areas like warehouses, or are parked in places where ambient light is insufficient due to which it becomes difficult for the operator during his/her ingress or egress under low lighting conditions.

Further such construction vehicles may be employed at night, i.e., under conditions of low ambient lighting. Such vehicles may be relatively large and may employ ladders, stairs, etc., for operator's approach. Approaching the machine or desired areas on the machine under low lighting conditions would be again difficult for the operator. Approaching the machine, under low natural lighting conditions, would be more convenient if a lighting system is provided to illuminate desired areas on the machine, e.g. the stairs or ladders.

The lighting systems known in the art dependent on operation of the machine in concern. Such lighting systems are inoperable during the machine's shutdown state. Further, conventional lighting systems functionalities are based on inputs received from one or more light or proximity sensors, or a combination thereof, due to which such lighting systems may be activated when any person or object is detected close to machine. Accordingly, the lighting system may be activated even when the person may not have an intention of climbing onto the machine.

U.S. Pat. No. 8,624,504 describes a lighting system which may provide supplemental lighting for the stairs of a vehicle under conditions of low ambient lighting. Supplemental lighting may be provided for at least a period of time desired for ingress and/or egress of the operator.

### SUMMARY OF THE DISCLOSURE

In one aspect of the present disclosure, a lighting system for a work machine is provided. The lighting system is configured to aid an operator approaching the work machine. The lighting system includes a plurality of step lights disposed on a stairway of the work machine. The lighting system further includes a lighting power source configured to provide power to the plurality of step lights for lighting, independently of an operational state of the work machine. The lighting system also includes a radio frequency identification reader configured to read a radio frequency identification tag associated with an operator. The lighting system further includes a lighting control module configured to receive a signal based on the reading of the radio frequency identification tag. The lighting control module further detects if the operator is proximate to the work machine based, at least in part, on the reading of the radio frequency identification tag. The lighting control module further triggers an activation of the plurality of step lights based on the detection of the operator proximate to the work machine.

Other features and aspects of this disclosure will be apparent from the following description and the accompanying drawings.

### BRIEF DESCRIPTION OF THE DRAWINGS

FIG. 1 is a perspective view of an exemplary machine, according to one embodiment of the present disclosure;

FIG. 2 is a block diagram of a lighting system employed on the machine of FIG. 1, according to one embodiment of the present disclosure; and

FIG. 3 is another perspective view of the machine of FIG. 1, showing an operation of the lighting system, according to one embodiment of the present disclosure.

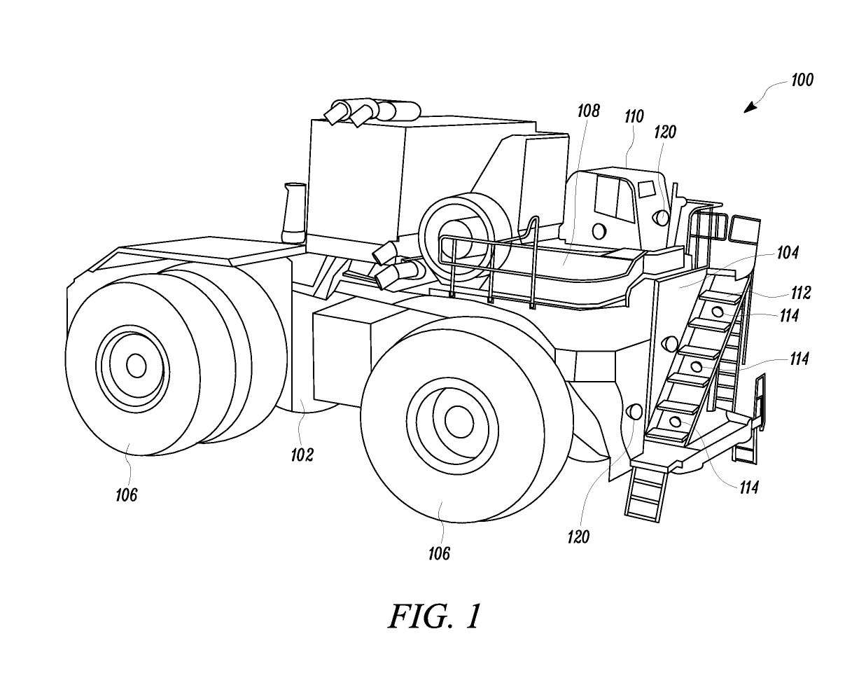

### DETAILED DESCRIPTION

Wherever possible, the same reference numbers will be used throughout the drawings to refer to the same or similar parts. Referring to FIG. 1, an exemplary machine 100 is illustrated. More specifically, the machine 100 is an off-highway tractor. In other embodiments, the machine 100 may be associated with an industry, such as, construction, mining, forestry, agriculture, waste management, material handling, transportation, and so on. Accordingly, in other embodiments, the machine 100 may be a haul truck, a mining truck, and so on.

The machine 100 includes a frame 102. The frame 102 is configured to support and/or mount one or more components of the machine 100. The machine 100 includes an enclosure 104 provided on the frame 102. The enclosure 104 is configured to house an engine or any other power source, such as, batteries. The engine is configured to provide power to the machine 100 for operational and mobility requirements. The machine 100 includes one or more ground engaging members 106, such as, wheels. The ground engaging members 106 are configured to provide mobility to the machine 100 on ground.

The machine 100 includes a platform 108 provided on the frame 102. The platform 108 provides access to various locations on the machine 100 for operational and/or maintenance purpose. The machine 100 includes an operator cabin 110 provided on the frame 102. The operator cabin 110 may be accessed via the platform 108. The operator cabin 110 may include one or more control devices (not shown) such as, a joystick, a steering wheel, pedals, levers, buttons, switches, and so on. The control device is configured to enable the operator to control the machine 100 on the ground. The operator cabin 110 may also include an operator interface, such as, a display device, a sound source, a light source, or a combination thereof. The operator interface may provide information to the operator related to various machine parameters.

The machine 100 further includes a stairway 112 adjacent to the enclosure 104 provided on the frame 102. The stairway 112 is used by the operator of the machine 100 to access the platform 108 and the cabin 110 for designated purposes. The machine 100 further includes a plurality of step lights 114 disposed on the stairway 112. In an embodiment, the plurality of step lights 114 is configured to aid the operator in his/her approach towards the machine 100 under low or no ambient lighting conditions. Further, a plurality of lights 120 may be disposed on the enclosure 104, or around the platform 108 and the cabin 110. In another embodiment, various other lights may be positioned around the machine 100, which when illuminated may aid the operator in locating certain areas of the machine 100 during low ambient light conditions.

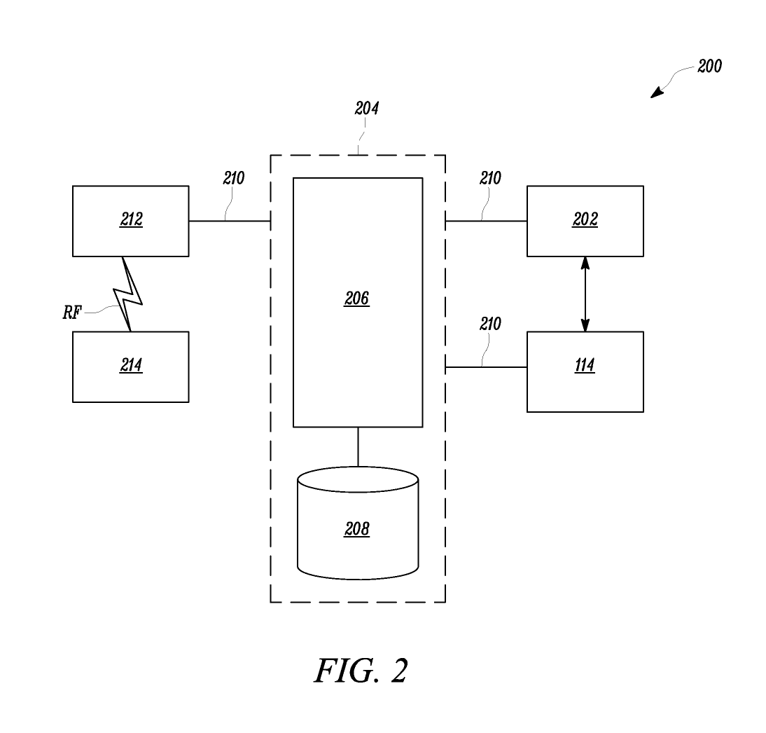

Referring to FIG. 2, an exemplary lighting system 200 associated with the machine 100 is illustrated, according an embodiment of the present disclosure. The lighting system 200 is configured to aid the operator in his/her approach towards the machine 100 under low or no ambient lighting conditions. The lighting system 200 includes the plurality of step lights 114 disposed on the machine 100 as described earlier. The plurality of step lights 114 can be of any type, number, size, shape, etc. For example, the plurality of step lights 114 and the plurality of lights 120 can be one or more of incandescent, halogen, gas discharge, florescent, fiber optic, induction, and light emitting diode (LED), etc. source. A person of ordinary skill in the art will appreciate that the plurality of step lights 114 may be arranged in any suitable formation to disperse light over a desired area of the machine 100.

The plurality of step lights 114 may include a housing (not shown) constructed of plastic, metal, and/or substantially any matter to house a light source of the step light therein. For instance, at least a portion of the housing may enable light emitted by each of the plurality of step lights 114 to pass there through (e.g., at least a portion of the housing may be made of a light-transmitting material that is transparent, translucent, frosted, or colored in nature). Additionally or alternatively, light generated by the housing may be omitted and each of the plurality of step lights 114 may be emitted in an unobstructed manner.

As shown in FIG. 2, the plurality of step lights 114 is in communication with a lighting power source 202. The lighting power source 202 is coupled to the plurality of step lights 114 to supply power for operation of the plurality of step lights 114. For instance, the lighting power source 202 can provide direct current (DC) power to the plurality of step lights 114. Further, in an example, in one embodiment, the lighting power source 202 may also be coupled to the plurality of lights 120, so that the plurality of lights 120 may serve as emergency backup lights in case a failure event occurs for the plurality of step lights 114.

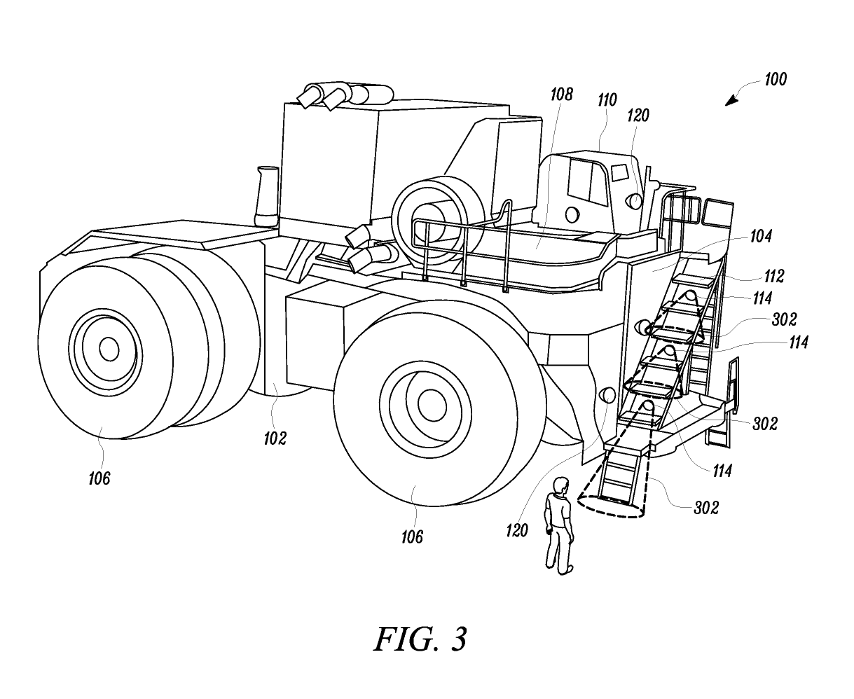

The lighting power source 202 may include one or more batteries. For instance, the lighting power source 202 can be any number, size, and type of rechargeable e.g., nickel-cadmium and/or non-rechargeable e.g., alkaline batteries. The operation of each of the plurality of step lights 114 is qualified into an inactive state (see FIG. 1) or an active state (see FIG. 3). The active state is defined by a lighting event of the plurality of step lights 114 on receiving power from the lighting power source 202.

Alternatively, the lighting power source 202 may be a solar cell. Moreover, the lighting power source 202 may be a combination of a solar cell and one or more batteries. Thus, for instance, a battery may supplement power supplied by the solar cell (or vice versa) and/or the solar cell can recharge a battery. The lighting power source 202 may wirelessly obtain power (e.g., to be utilized directly, employed to recharge batteries); for instance, power can be wirelessly delivered to the lighting power source 202 via collecting RF energy from the environment, electromagnetic induction, wave coupling, converting motion or heat to electrical energy, and the like. The lighting power source 202 is operable independent of the power source of the machine 100. Hence, the power supplied to the plurality of step lights 114 for attaining the active state is independent of the operation of the machine 100 i.e., the plurality of step lights 114 will continue to receive power for attaining the active state irrespective of whether the machine 100 is in operation or not.

The lighting system 200 further includes a control tool 204 in communication with the plurality of step lights 114 and the lighting power source 202. The control tool 204 includes a lighting control module 206 and a database 208 in communication with the lighting control module 206. The lighting control module 206 may retrieve data from and store data in the database 208. The lighting control module 206 may be a computing microprocessor known in the art. The lighting control module 206 may include hardware specifically constructed for performing various processes and operations of the disclosure or may include a general purpose computer or computing platform selectively activated or reconfigured by program code to provide the necessary functionality.

The lighting control module 206 is in communication with the plurality of step lights 114 and the lighting power source 202 via a datalink 210 for receiving data from, and sending instructions thereto. The datalink 210 may be a hardwire link or via wireless connection, such as modem, infrared, RF or Bluetooth technology. The lighting control module 206 is configured maintain the active state or the inactive state of the plurality of step lights 114 by modulating power as received from the lighting power source 202. The lighting control module 206 can further alter intensity, brightness, color (e.g., wavelength, frequency), etc. of the light yielded by the plurality of step lights 114.

The lighting system 200 further includes a radio frequency identification (RFID) reader 212 disposed on the machine 100. Alternatively, the RFID reader 212 may be positioned remote from the machine 100. The lighting control module 206 is in communication with the RFID reader 212 via the datalink 210. The RFID reader 212 may be a Passive Reader Active Tag (PRAT) system, an Active Reader Passive Tag (ARPT) system, an Active Reader Active Tag (ARAT) system, a Battery-Assisted Passive (BAP) system or the like readers.

The RFID reader 212 is configured to receive an input signal that can be leveraged by the lighting control module 206 to manipulate operation of the plurality of step lights 114. The input signal can be a radio frequency (RF) signal communicated from a radio frequency (RF) transmitter that can be utilized by the lighting control module 206 to control operation of the plurality of step lights 114. In an embodiment, the RF transmitter is a radio frequency identification (RFID) tag 214 associated with the operator of the machine 100. For example, certain designated workers may be provided with a vest containing the RFID tag 214. Accordingly, in this case, the RFID tag 214 is worn by the operator. The RFID reader 212 receives the RF signal from the RFID tag 214 as the operator approaches the machine 100 or is proximate to the machine 100 such that the RFID reader 212 may read the RFID tag 214. The vicinity of detection or sensing of the RFID tag 214 may be defined by a monitoring range associated with the RFID reader 212. The RFID tag 214 may be a passive, active, battery-assisted passive or the like tags known in the art. A person of ordinary skill in the art will appreciate that the association of the RFID tag 214 with the operator of the machine 100 explains the uniqueness of any barcode, QR code etc. of the RFID tag 214 assigned with the operator of the machine 100. The RFID tag 214 may be worn or provided in close contact with the operator, for example, the RFID tag 214 may be present on a helmet, a keychain, handheld equipment or the like articles associated with the operator of the machine 100.

Accordingly, when the operator wearing the RFID tag 214 approaches the machine 100, the RF signal as transmitted by the RFID tag 214 and received by the RFID reader 212 is deciphered by the lighting control module 206. The lighting control module 206 receives a signal from the RFID reader 212 indicating that the RFID reader 212 has read the RFID tag 214 associated with the operator, when the operator approaches the machine 100. Further, the lighting control module 206 may detect if the operator is proximate to the machine 100 based on the signal received from the RFID reader 212. When the operator is detected, the lighting control module 206 triggers an activation of the plurality of step lights 114 from the inactive state to the active state, changing a light color or a light intensity provided by the plurality of step lights 114, and the like. As explained earlier, in some embodiments, signals from the plurality of sensors may also be considered to trigger the activation of the plurality of step lights 114.

Additionally or alternatively, the lighting system 200 may also include a plurality of sensors provided on the machine 100. The plurality of sensors may include one or more light sensors configured to monitor ambient lighting around the machine 100, one or more proximity sensors configured to monitor the presence of the operator proximate to the machine 100. Accordingly, based on the input received from the RFID reader 212 and any of the plurality of sensors, the lighting control module 206 may effectuate adjustments associated with the lighting of the plurality of step lights 114. Although, the lighting control module 206 may simultaneously illuminate each of the plurality of step lights 114 in the active state, however in an alternative embodiment, the lighting control module 206 may sequentially illuminate the plurality of step lights 114 based on the nearness of the operator to the machine 100.

FIG. 3 illustrates the active state of the plurality of step lights 114. The RFID reader 212 of the lighting system 200 periodically monitors for detection of the RF signal based on the RFID tag 214 associated with the operator. Alternatively, the RFID reader 212 can continuously monitor for RF signals. As the operator approaches the machine 100, the RF signal through the RFID tag 214 associated with the operator is detected and read by the RFID reader 212. The RF signal is further decoded by the lighting control module 206. Additionally, the lighting control module 206 may receive inputs from the plurality of sensors mentioned earlier. The lighting control module 206 further controls the lighting power source 202 for effectively providing power to the plurality of step lights 114.

Accordingly, the lighting control module 206 triggers the activation of the plurality of step lights 114, from the inactive state to the active state, as illustrated by light zones 302 associated with each of the plurality of step lights 114, to aid the operator during his/her approach towards the machine 100. The light zones 302 may adequately illuminate desired areas of the machine 100. A person of ordinary skill in the art will appreciate that the location of the light zones 302 illustrated in the accompanying figures is exemplary. The light zones 302 may vary in number and location. Further, an intensity and range of the light zones 302 may be adjusted based on the application.

In one embodiment, the lighting control module 206 may include a sleep timing mechanism to inactive the plurality of step lights 114 based on monitoring the operator's approach towards the machine 100. Accordingly, the lighting control module 206 may deactivate the plurality of step lights 114 if the operator is no longer proximate to the machine 100. In yet another embodiment, the lighting system 200 may be provided with a manual override mechanism. For example, a switch may be provided on the machine 100 to manually deactivate a functioning of the lighting system 200.

Although the lighting system 200 may be implemented as a software algorithm executed by a computer. It may be contemplated that the lighting system 200 may include multiple RFID reading devices disposed on the machine 100. In an embodiment, the multiple RFID reading devices may be in communication with a plurality of lighting control modules 206. Alternatively, a separate lighting control module 206 may be provided for each RFID reader device and each of the plurality of step lights 114. Further, the orientation and dimensions of the RFID reader device, RFID tags, step lights etc. are not limited to that described herein.

### INDUSTRIAL APPLICABILITY

The present disclosure relates to the lighting system 200 that utilizes RF signaling to control lighting associated with the plurality of step lights 114. The lighting system 200 includes the lighting control module 206 in communication with the lighting power source 202, the plurality of step lights 114, and the RFID reader 212. The RFID reader 212 is configured to receive the RF signal from the RFID tag 214 associated with the operator of the machine 100.

During low ambient light conditions, for example, when the machine 100 is parked in a mine, when the operator approaches the machine 100 and enters within the monitoring range of the RFID reader 212, the RF signal from the RFID tag 214 associated with the operator is received by the RFID reader 212, and further by the lighting control module 206. The lighting control module 206 may also receive inputs from the plurality of light and proximity sensors along with the RF signal as mentioned above. The lighting control module 206 further commands the lighting power source 202 to supply power to the plurality of step lights 114 to trigger the active state corresponding to illumination of the plurality of step lights 114.

The lighting system 200 of the present disclosure may increase the overall efficiency of the machine 100 in view of providing flexibility for the operators of the machine 100. The lighting system 200 may also optimize power consumption. By using radio frequency identification (RFID) to identify the operators designated for the machine 100, the lighting system 200 is activated based on approach and detection of only desired individuals near the machine 100. In one embodiment, the manual overriding mechanism associated with the lighting system 200 enables selective operation of the lighting system 200.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A lighting system associated with a work machine, the lighting system configured to aid an operator approaching the work machine, the lighting system comprising:
a plurality of step lights disposed on a stairway of the work machine, each of the plurality of step lights configured to be in any one of an active state or an inactive state;
a lighting power source in communication with each of the plurality of the step lights, the lighting power source configured to provide power to the plurality of step lights for lighting thereof, wherein the lighting power source is configured to operate independently of an operational state of the work machine;
a radio frequency identification reader disposed on the work machine, the radio frequency identification reader configured to read a radio frequency identification tag associated with the operator, wherein the radio frequency identification tag is worn by the operator; and
a lighting control module in communication with the plurality of step lights, the lighting power source, and the radio frequency identification reader, the lighting control module configured to:
receive a signal based on the reading of the radio frequency identification tag associated with the operator;
detect if the operator is proximate to the work machine based, at least in part, on the reading; and
trigger an activation of the plurality of step lights based on the detection of the operator proximate to the work machine.
